(19) United States
(12) Patent Application Publication
(10) Pub. No.: US 2008/0171670 A1
(43) Pub. Date: Jul. 17, 2008

(54) Oil Base Fluids and Organophilic Tannin-Containing Compositions to Lower the Fluid Loss Thereof

(76) Inventors: Jack C. Cowan, Lafayette, LA (US); Roy F. House, Houston, TX (US); Julie B. Morgan, Houston, TX (US); James A. Meyer, Rayne, LA (US)

Correspondence Address: ROY F. HOUSE, 5726 ETTRICK STREET, HOUSTON, TX, 77035, US

(21) Appl. No.: 10/569,529

(22) PCT Filed: Sep. 11, 2004
(86) PCT No.: PCT/US2004/029531

§ 371 Date: Feb. 24, 2006

(51) Int. Cl. C09K 8/60

(52) U.S. Cl. 507/206

(57) ABSTRACT

The invention provides a fluid loss control additive for oleaginous liquids and oleaginous wellbore fluids containing the additive. The additive is the reaction product of a tannin compound, a polyamidoamine, a commercial lecithin, and an acid. The preferred tannins are derived from quebracho and wattle trees. The preferred acid is sulfuric acid. The preferred polyamidoamine is a long-chain fatty alkyl partial amide which is the reaction product of a polyalkylenepolyamine and a fatty acid containing from about 8 to about 30 carbon atoms, most preferably tall oil fatty acids, wherein at least one of the amino groups of the polyalkylenepolyamine is not amidated. The commercial lecithin contains from about 30% to about 50% of the vegetable oil from which the lecithin is concentrated, preferably soybean oil, and is present in the additive in an amount from about 1% to about 3% by weight, based on the weight of the tannin. Preferably the additive contains greater than 15% by weight of the polyamidoamine, based on the weight of the tannin.

This patent application is a 35 U.S.C. 371 National Stage filing of PCT application number PCT/US2004/029531 filed 11 Sep. 2004 which claims priority to U.S. Provisional application No. 60/502,717 filed Sep. 12, 2003.

### FIELD OF THE INVENTION

The present invention relates to oleaginous wellbore fluids containing a base oil having dispersed therein a novel fluid loss control additive, and systems and processes for using them in a subterranean formation in oil and gas recovery operations. The wellbore fluids may be all oil or invert emulsions and are characterized with a low fluid loss at elevated temperatures.

### PRIOR ART

In the drilling of wells for oil and gas by the rotary method, it is common to use a circulating fluid which is pumped down to the bottom of the well through a drill pipe, where the fluid emerges through ports in the drilling bit. The fluid rises to the surface in the annular space between the drill pipe and the walls of the hole, and at the surface it is treated to remove cuttings and the like to prepare it for recirculation into the drill pipe. The circulation is substantially continuous while the drill pipe is rotated.

An important feature of oil base well working fluids of the class described is their ability to resist filtration. In most instances when they are in actual use, whether as drilling fluids, packer fluids, fracturing or completion fluids, the well working fluid is in contact with a more or less permeable formation, such as, for example, sandstone, sandy shale and the like, with an effective balance of pressure such that the fluid tends to be forced into the permeable formation. When a well working fluid is deficient in its ability to resist filtration, then the solids in the fluid are held back by the permeable formation and build up as a filter cake or sludge on its surfaces, while the liquid per se of the well working fluid filters into the permeable formation. The filter cake or sludge thus formed is generally very undesirable. Moreover, the loss of oil to the formation is very expensive, not only because of the cost of the oil itself, but also due to the cost of maintaining the properties and composition of the fluid.

Various additives have been used or suggested for use as fluid loss additives to prevent or decrease this loss of fluid by filtration from oil base muds. Some of the first materials used for this purpose were asphalt and various modified asphaltic materials. The following U.S. patents all disclose various amine derivatives of various polyphenolic compounds for use as fluid loss control (hereinafter sometimes referred to as FLC) additives for oil base muds: Jordan et al. U.S. Pat. No. 3,168,475; Jordan et al. U.S. Pat. No. 3,281,458; Beasley et al. U.S. Pat. No. 3,379,650; Cowan et al. U.S. Pat. No. 3,232,870; Cowan et al. U.S. Pat. No. 3,425,953; Andrews et al. U.S. Pat. No. 3,494,865; Andrews et al. U.S. Pat. No. 3,671,427; Andrews et al. U.S. Pat. No. 3,775,447; Kim U.S. Pat. No. 3,538,071; Kim U.S. Pat. No. 3,671,428; Cowan U.S. Pat. No. 4,421,655; House U.S. Pat. No. 4,569,799; House et al. U.S. Pat. No. 4,597,878; Cowan et al. U.S. Pat. No. 4,737,295; Cowan et al. U.S. Pat. No. 4,853,465; Patel et al. U.S. Pat. No. 4,637,883; and Patel et al. U.S. Pat. No. 4,710,586.

Jordan et al. U.S. Pat. Nos. 3,168,475 and 3,281,458 disclose certain substituted ammonium salts of humic acid. Compounds useful in the practice of their invention can be represented by the formula [R₁R₂R₃R₄N]⁺Hu wherein at least one of the R's is an alkyl radical having from 12 to 22 carbon atoms in a straight chain, and in which those R's which do not 60 have from 12 to 22 carbon atoms in a straight chain are chosen from the group consisting of hydrogen, alkyl radicals having fewer than 12 carbon atoms, phenyl, and benzyl; wherein Hu is the anion of humic acid; wherein the term “alkyl” includes unsaturated alkyl chains, such as, for example, oleyl as well as stearyl; and wherein at least one of the alkyl radicals having from 12 to 22 carbon atoms may be attached to the nitrogen atom indirectly through an intermediate linkage, most generally a heterocylic carbon-nitrogen ring.

Beasley et al. U.S. Pat. No. 3,379,650 discloses various additives (dispersants) which facilitate the dispersion of long chain alkyl ammonium humates in organic liquids. Such humates are more readily dispersible in some organic liquids than in others. The dispersibility of these humates is also dependent to some extent on their processing during manufacture. Thus drying these long chain alkyl ammonium humates decrease their dispersibility.

Andrews et al. U.S. Pat. No. 3,494,865 discloses an adduct prepared by reacting humic acid with from about 50% to about 110% of its base-combining capacity, with certain fatty acid partial amides of a polyalkylene polyamine having from 3 to 7 amino groups. The amide is only partial such that from about one-third to about two-thirds of the nitrogen atoms are present in the form of a fatty acid amide, the balance being in the form of free amino groups. As stated therein at column 3, lines 10-12. “The adduct as described and wherein the partial amide is present to the extent of about 110% of the base-combining capacity of the humic acid probably represents salt formation for 100%, the remaining 10% being absorption, although in view of the complicated nature of the constituents, exact structural analysis is difficult and somewhat uncertain. Also, depending on the drying temperature, where heat is used for such a step, the adduct may undergo a certain extent of amidification where the amine groups of the polyamines are combined with the carboxyl groups of the humic acid.” Andrews et al. discuss the dispersion of such adducts in well working fluids and further discloses certain dispersants which are desirable to expedite the dispersion of the adducts without depending on down-hole circulation of the well working fluids.

Andrews et al. U.S. Pat. No. 3,671,427 discloses certain adducts of humic acid and a fatty acyl partial amide of a polyalkylene polyamine having from 3 to 7 amino groups wherein the partial amide is linked to the humic acid by an amide linkage. The amide is only partial such that from one to all but one of the nitrogen atoms are present the form of a fatty acid amide, the balance being in the form of free amino groups.

Cowan U.S. Pat. No. 4,421,655 discloses certain organophilic derivatives of various polyphenolic acids as fluid loss additives for oil base well working fluids. The derivatives comprise complex salts of a polyphenolic acid, an amino compound, and a polyvalent metal compound. The amino compound includes partial amides of polyalkylenepolyamines containing at least two primary, secondary, or tertiary amino groups per molecule.

Beasley et al. U.S. Pat. No. 3,325,537 discloses certain salts for solublizing lignite in water to achieve a solublization of at least 65% by weight and at the same time obtain a resulting pH within the limit of 5.2 to 7.5. Such lignite solutions are disclosed to be useful in preparing long chain alkyl ammonium humates.

Generally speaking, the substituted ammonium humates disclosed in these prior art patents may be produced by bringing together humic acid and the substituted ammonium compound in its base form. The base and the acid neutralize each other with salt formation to produce the desired humate derivative. Another general method of preparation disclosed is to convert the humic acid to a simple salt by reaction with an alkali, so as to produce sodium humate, potassium humate, ammonium humate, and the like, by reaction with alkali metal or ammonium bases, respectively. The substituted ammonium compound is caused to be present in the form of a simple salt or in quaternary ammonium form. Thus the free amine groups may be reacted with a simple acid such as hydrochloric, acetic, and the like to give the corresponding substituted ammonium chloride or acetate, respectively. This method of procedure is stated to have the advantage that the substituted ammonium salts and quaternary ammonium salts, and the simple humates as described are both water soluble, so that solutions of each reactant may be made, and the reaction completed by mixing solutions thereof together. Mixtures of water with methanol, ethanol, isopropanol, acetone, and the like may be needed for some substituted ammonium salts and quaternary ammonium salts.

While various of these additives have found utility as fluid loss additives in oil-base muds, their solubility or dispersibility is such as to require the presence of a dispersant in the additive composition or oil base mud. See for example the cited Beasley et al. U.S. Pat. Nos. 3,379,650 and Andrews et al. 3,494,865.

Because of increasing concern over the environmental problems associated with the use of oil base muds in which diesel oil, crude oil, or like oleaginous liquids are used as the continuous phase, oil base drilling fluids based on less-toxic oils are increasing in popularity. These oils, being more highly refined and generally containing a low content of aromatic compounds, have less solvency for the organophilic polyphenolic fluid loss additives of the prior art. Thus the solubility or dispersibility of these additives in such oils is less than in diesel oil, etc., and generally a dispersant or enhanced concentration of dispersant is necessary to adequately prepare oil base drilling fluids based such less-toxic mineral oils.

### SUMMARY OF THE INVENTION

The present invention pertains to wellbore fluids employing an oil phase and a novel organophilic tannin-containing composition fluid loss control additive characterized by a low fluid loss after aging at elevated temperatures of 148.9° C. (300° F.) or above.

The organophilic tannin-containing composition is the reaction product of a polyamidoamine such as a long-chain fatty acyl partial amide, a commercial lecithin, and a tannin together with an acid wherein the concentration of the commercial lecithin is from about 1% to about 3% based on the weight of the tannin.

Accordingly, it is an object of the invention to provide wellbore fluids containing a base oil phase (preferably a low-toxicity oil) and a novel organophilic tannin-containing composition FLC additive which are characterized by a low fluid loss after aging the fluids at elevated temperatures of 148.9° C. (300° F.) or above.

It is another object of the invention to provide a FLC additive, which is effective at elevated temperatures of 148.9° C. (300° F.) or above in oleaginous base oils, which does not require the use of a dispersant.

Another object of the invention is a process selected from the group consisting of drilling, working over, completing, fracturing, and packing, wherein the wellbore fluid contains a low-toxicity base oil phase and an organophilic tannin-containing composition FLC additive which is the reaction product of a polyamidoamine such as a long-chain fatty acryl partial amide, a tannin, and an acid, preferably sulfuric acid.

While the invention is susceptible of various modifications and alternative forms, specific embodiments thereof will hereinafter be described in detail and shown by way of example. It should be understood, however, that it is not intended to limit the invention to the particular forms disclosed, but on the contrary, the invention is to cover all modifications and alternatives falling within the spirit and scope of the invention as expressed in the appended claims.

The compositions can comprise, consist essentially of, or consist of the stated materials. The method can comprise, consist essentially of, or consist of the stated steps with the stated materials.

### DETAILED DESCRIPTION OF THE INVENTION

The oils for use in the wellbore fluids of this invention are well known in the art. In many areas of the world, low toxicity oils have been developed over the last several years as environmental restrictions have been placed on the toxicity of wellbore fluids. Generally such oils have a very low content of aromatic compounds, preferably less than about 0.1%, most preferably no aromatic compounds.

Low-toxicity oils useful in the fluids of this invention include: branched-chain paraffins (such as those disclosed in Mercer U.S. Pat. No. 5,096,883, incorporated herein by reference); non-hydrocarbon, non-mineral oil polymers (such as those disclosed in Younes U.S. Pat. No. 5,470,822, incorporated herein by reference); linear paraffins (such as those disclosed in Growcock et al. U.S. Patent Application Publication US 2003/0098180A 1, incorporated herein by reference); synthetic hydrocarbons synthesized from one or more alphaolefinic monomers (such as those disclosed in Patel U.S. Pat. No. 5,869,433, incorporated herein by reference); synthetic esters (such as those disclosed in Patel U.S. Pat. No. 5,977,031, Mueller et al. U.S. Pat. Nos. 5,106,516 , 5,232,910, and 5,318,956, all incorporated herein by reference); internal (isomerized alpha) olefins; synthetic ether, low aromatic content (<0.5 weight percent aromatic) refined mineral oils (such as Exxon Mobil's Escaid 90 and Escaid 110, Conoco's LVT 200, and Shell Oil Company's Shellsol DMA); and paraffins prepared, at least in part, by a Fischer-Tropsch process containing less than 0.1 volume percent aromatics (such as those disclosed in Van Slyke U.S. Pat. No. 6,255,256, incorporated herein by reference).

Although the wellbore fluids of this invention have been described as containing a low-toxicity oil phase, it is to be understood that the novel organophilic tannin-composition fluid loss control additive of this invention is also effective in decreasing the fluid loss of any oleaginous fluid such as diesel oil, crude oil, and the like.

It is known as indicated hereinbefore that various amine-treated polyphenolic materials, particularly humic acid-containing materials such as naturally occurring oxidized lignite (Leonardite), are effective FLC additives for oleaginous base wellbore fluids. However, it has been found that such FLC additives have poor dispersibility in the low-toxicity oils as set forth herein thus requiring a dispersant to be present in the FLC additive or in the low-toxicity base oil.

We have now found that FLC additives which are the reaction product of a long-chain fatty acyl partial amide, a commercial lecithin, wherein the concentration is from about 1% to about 3% by weight based on the weight of the tannin, a tannin extract, together with an acid have excellent dispersibility in oils including low-toxicity oils imparting a low fluid loss to the oils after aging at elevated temperatures of 148.9° C. (300° F.) and above (and, of course, at lower temperatures).

Sources of tannin extracts—Tannin occurs in nearly every plant from all over the world, in all climates. It is found in almost any part of the plant, from root to leaves, bark to unripe fruit. Most trees contain plenty of tannin. It is concentrated in the bark layer. There are two types of tannins: catechol and pyrogallol.

Typical plants used for extracting tannins include any of the oaks, fir, certain willows, chestnut, sumac leaves, oak galls, canaigne root, birch, alder, hemlock, quebracho, mimosa, spruce, wattle and the like. The tannin is typically extracted from the tannin source, preferably bark, in water at elevated temperatures. A sulfite or bisulfite salt may be added to decrease the extraction time. The extracted liquor is usually spray dried to obtain a dry, free flowing tannin extract.

The preferred tannin extracts for use in this invention are quebracho tannin and wattle tannin, most preferably wattle tannin.

The amino compounds which may be used in this invention include polyamidoamines which contain at least one primary or secondary amine group per molecule selected from the group consisting of (I), (II), (III), (IV) and mixtures thereof:

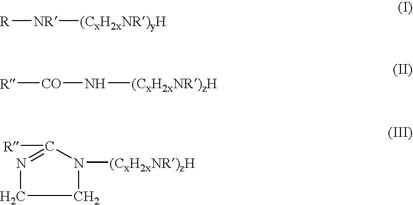

where x, y, and z are integers wherein 2≦x≦3; y≧1; z≧2; R is an aliphatic group containing from 8 to 30 carbon atoms; R′ is selected from the group consisting of H and R″—O, and mixtures thereof; R″ is an aliphatic group containing from 7 to 29 carbon atoms; and wherein at least one of the R′ groups are H.

The amine compound may also be a quaternary ammonium compound obtained by quaternizing the above compounds such that the amino H atoms are replaced with an alkyl group containing 1 to 3 carbon atoms, a benzyl group, or mixtures thereof, and excess of the quaternizing reagent is used sufficient to effect the quaternization of the amino group.

Preferably x=3 in the compounds represented by formula I and x=2 in the compounds represented by formulas II and III. Preferably 1≦y≦7, 2≦z≦8, R is an aliphatic group containing from 12 to 22 carbon atoms, and R″ is an aliphatic group containing from 11 to 21 carbon atoms. Most preferably at least 65% of the aliphatic radicals represented by R contain 18 carbon atoms, and at least 65% of the aliphatic groups represented by R″ contain 17 carbon atoms. Still more preferably the R″ group is derived from tall oil fatty acid.

In the foregoing as well as elsewhere in this specification and the claims which follow, the term aliphatic is to understood as including unsaturated as well as saturated (alkyl) straight carbon chain radicals, and straight carbon chain radicals which contain one or more hydroxyl or amino groups substituted therein.

By way of further explanation of the nature and types of the amino compounds utilized in the present invention are some typical members of the series in the following table, although these are merely illustrative and not at all by way of limitation.

### GROUP I

### R—NH—C₃H₆NH—CO—R″

### R—NH—C₃H₆—NH—C₃H₆—NH—CO—R″

### R—NH—C₂H₄—NH—C₂H₄—NH—CO—R″

### R—NH—C₂H₄—NH—C₂H₄—N(COR″)C₂H₄—NH—CO—R″

### R—NH—C₃H₆—N(CO—R″)—C₃H₆—NH—C₃H₆—NH—CO—R″

### GROUP II

### R″—CO—NH—C₂H₄—NH—C₂H₄—NH₂

### R″—CO—NH—C₂H₄—NH—C₂H₄—NH—C₂H₄—NH—CO—R″

### R″—CO—NH—C₂H₄—NH—[C₂H₄—N(—CO—R″)—]₂—C₂H₄—NH₂

### R″—CO—NH—(C₂H₄—NH)₂—[C₂H₄—N(—CO—R₂″)]₂H

### R″—CO—NH—(C₂H₄—NH)₃—[C₂H₄—N(—CO—R″)]₂H

### R″—CO—NH—(C₂H₄—NH)₂—[C₂H₄—N(—CO—R″)]₃H

### R″—CO—NH—(C₂H₄—NH)₂—[C₂H₄—N(—CO—R″)]₄H

### R″—CO—NH—(C₂H₄—NH)₂—[C₂H₄—N(—CO—R″)]₅H

### R″—CO—NH—(C₂H₄—NH)₃—[C₂H₄—N(—CO—R″)]₅H

### R″—CO—NH—(C₂H₄—NH)₂—[C₂H₄—N(—CO—R″)]₆H

### R″—CO—NH—(C₂H₄—NH)₃—[C₂H₄—N(—CO—R″)]₆H

### GROUP III

### R′″—C₂H₄—NH—CO—R″

### R′″—(C₂H₄—NH)₂—C₂H₄—NH—CO—R″

### R′″—C₂H₄—NH—C₂H₄—N(CO—R″)—C₂H₄—NH₂

### R′″—(C₂H₄—NH)₃—C₂H₄—NH—CO—R″

### R′″—(C₂H₄—NH)₂—[C₂H₄—N(CO—R″)]₂H

### R′″—(C₂H₄—NH)₂—[C₂H₄—N(CO—R″)]₅H

where R′″ is the imidazoline group

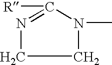

The amino compound for use in the present invention also includes (IV) the reaction product of an oxidized hydrocarbon wax and a polyalkylene polyamine in which at least one amino group of the polyalkylenepolyamine is not amidated.

Suitable oxidized hydrocarbon waxes which are modified according to the invention include synthetic and mineral waxes which in the oxidized state still exhibit the properties of a wax, e.g. oxidized lignite wax, oxidized microcrystalline wax, oxidized polyolefin wax, particularly oxidized polyethylene wax, and oxidized Fischer-Tropsch wax. Such oxidized waxes contain carboxy acid groups and optionally carboxy acid ester groups which may be partially saponified. Oxidized Fischer-Tropsch waxes include also those obtained by oxidative synthesis. Preferred oxidized waxes are oxidized microcrystalline waxes, oxidized Fischer-Tropsch waxes, oxidized polyethylene waxes and such waxes which have in addition been partially saponified. Oxidized polyethylene waxes and partially saponified, oxidized polyethylene waxes are particularly preferred.

Waxes of the type mentioned above and used as starting material are known and are generally characterized by the drop point, hardness (as measured by the penetration value according to standard methods such as ASTM-D-1321), saponification number and acid number. They have preferably a drop unit of at least 80° C., and advantageously of at most 140° C., more preferably within 85°-130° C.; a hardness or penetration value according to ASTM D-1321≦20, preferably of 1 to 10; a saponification value of from 10 to 120, preferably 20 to 80; and an acid number of from 5 to 80, preferably 10 to 60. The specific gravity is generally of from 0.9 to 1.05 and the molecular weight may be between 500 and 20,000, preferably 500 to 5000, more preferably 1000 and 5000.

Such oxidized hydrocarbon waxes are well known and processes for oxidizing hydrocarbons are well known. These generally comprise blowing air or oxygen-containing gases through the liquid hydrocarbon at temperatures in the range from about 150° C. to about 180° C. until the desired degree of oxidation is achieved. See for example the following U.S. patents, incorporated herein by reference: U.S. Pat. Nos. 4,186,077; 4,198,285; 4,378,998.

The polyalkylene polyamines reacted with the oxidized hydrocarbons are as set forth hereinbefore, preferably polyethylene polyamines having from 3 to about 9 amino groups.

The preferred amino compounds for use in this invention are the fatty acyl partial amides, which may also be called fatty acid amido amines, from Group II which result from the reaction of fatty acids with polyalkylene polyamines. The preferred fatty acids contain from 8 to 30 carbon atoms, preferably from 12 to 18 carbon atoms. The preferred polyalkylene polyamines are polyethylene polyamines having from 3 to about 9 amino groups, and thus includes tri-amines such as diethylene triamine, tetra-amines such as triethylene tetramine, pentamines such as tetraethylene pentamine, and higher analogs of these, up to nine and more amino groups. The amide is only partial, that is, not all of the amine groups are amidated. Generally from about one-fourth to about three-fourths of the nitrogen atoms are present in the form of a fatty acid amide, the balance being in the form of free amino groups.

Most preferably the fatty acid is selected from the group consisting of tall oil fatty acid, hydrogenated tallow fatty acid, and mixtures thereof. The preferred fatty acyl partial amides of Group II have an average equivalent weight per amino group in the range from about 235 to about 850.

Mixtures of one or more of the amino compounds from Group I, Group II, or Group III make very desirable organophilic tannin derivatives for use in oil base well servicing fluids.

As noted hereinbefore, the organophilic tanning-containing compositions (hereinafter sometimes referred to as “OTCC”) FLC additives of this invention are the reaction product of a tannin extract, a polyamidoamine (preferably a long-chain fatty acyl partial amide), and an acid.

The acid may be an inorganic or an organic acid. Exemplary inorganic acids include sulfuric acid, hydrochloric acid, hydrobromic acid, and the like. Exemplary organic acids include acetic acid, proprionic acid, maleic acid, succinic acid, lactic acid, and anhydrides thereof and the like. The preferred acid is sulfuric acid.

The OTCC of this invention are prepared in a slurry process wherein the tannin extract is dissolved/dispersed in hot water, the acid added and the mixing continued while adding the amidoamine. Optionally but preferably there is thereafter added a base to raise the pH of the mixture to within the range from about 6 to about 11, preferably to about 10 followed by mixing therewith commercial semi-liquid lecithin.

Suitable optional bases include the alkaline earth metal oxides and hydroxides, the alkali metal hydroxides, and the like, preferably calcium oxide or calcium hydroxide.

Suitable lecithins are set forth in Cowan et al. U.S. Pat. No. 4,853,465, incorporated herein by reference. The preferred lecithin is commercial soybean lecithin containing from about 30% to about 50% of the vegetable oil from which the lecithin is concentrated, preferably soybean oil. Only a minor amount of the commercial soybean lecithin is incorporated into the OTCC of the invention, preferably from about 1% to about 3% by weight based on the weight of the tannin.

The oleaginous wellbore fluids of this invention may be essentially all-oil fluids or invert emulsion fluids in which the internal, dispersed hydrophilic phase, generally an aqueous phase and still more generally an aqueous salt solution, is present in an amount from about 5% to about 70% by volume, preferably from about 10% to about 60% by volume, and still more preferably from about 15% to about 50% by volume, all as is well known in the art. Thus the volumetric ratio of the oil phase to the aqueous phase in the wellbore fluids of this invention is from 100/0 to about 30/70, preferably from about 100/0 to about 50/50.

The invert emulsion wellbore fluids of this invention will contain one or more surfactants (e.g., emulsifiers, wetting agents) to stabilize the emulsion and generally will contain viscosifiers, weighting agents, and shale stabilizing salts in the dispersed, internal aqueous phase, and other additives as needed in addition to the OTCC FLC additive of the invention as disclosed herein. As used in the specification and claims, the term “surfactant” means a substance that, when present at low concentration in a system, has the property of adsorbing onto the surfaces or interfaces of the system and of altering to a marked degree the surface or interfacial free energies of those surfaces (or interfaces). As used in the foregoing definition of surfactant, the term “interface” indicates a boundary ,between any two immiscible phases and the term “surface” denotes an interface where one phase is a gas, usually air. Because the drilling fluids of the present invention are intended to be non-toxic, these optional ingredients, like the synthetic fluid, are preferably also non-toxic.

Exemplary emulsifiers include, but are not limited to, fatty acids, soaps of fatty acids, and fatty acid derivatives including amido-amines, polyamides, polyamines, esters (such as sorbitan monoleate polyethoxylate, sorbitan dioleate polyethoxylate), imidazolines, and alcohols.

Typical wetting agents include, but are not limited to, lecithin, fatty acids, crude tall oil, oxidized crude tall oil, organic phosphate esters, modified imidazolines, modified amidoamines, alkyl aromatic sulfates, alkyl aromatic sulfonates, and organic esters of polyhydric alcohols.

Exemplary weighting agents include, but are not limited to barite, iron oxide, gelana, siderite, and calcium carbonate.

Common shale inhibiting salts are alkali metal and alkaline-earth metal salts. Calcium chloride and sodium chloride are the preferred shale inhibiting salts.

Exemplary viscosifiers include, but are not limited to, organophilic clays (e.g., hectorite, bentonite, and attapulgite), non-organophilic clays (e.g., montmorillonite (bentonite), hectorite, saponite, attapulgite, and illite), oil soluble polymers, polyamide resins, and polycarboxylic acids and soaps. (As used in the specification and claims, the term “non-organophilic clay” means a clay which has not been amine-treated to convert the clay from water-yielding to oil-yielding.) The oleaginous wellbore fluids of this invention may contain other FLC additives in addition to the OTCC FLC additives of this invention.

Illustrative of such FLC additives include, but are not limited to, asphatics (e.g. asphaltenes and sulfonated asphaltenes), amine treated lignite, gilsonite, and polymers.

Exemplary polymers include, but are not limited to, polystyrene, polybutadiene, polyethylene, polypropylene, polybutylene, polyisoprene, natural rubber, butyl rubber, polymers consisting of at least two monomers selected from the group consisting of styrene, butadiene, isoprene, and vinyl carboxylic acid.

General invert emulsion wellbore fluid formulations are set forth in the following Table A.

TABLE A

| Ingredient | Typical |
|---|---|
| Low toxicity oil, volume %^{a} | 25-85 |
| Surfactant (active) | |
| ppb^{b} | 0.5-25 |
| kg/m³ | 1.43-71.5 |
| Weighting agent | |
| ppb | up to 700 |
| kg/m³ | up to 2002 |
| Polymer viscosifier | |
| ppb | 0.05-15 |
| kg/m³ | 0.143-42.9 |
| Organophilic clay | |
| ppb | up to 15 |
| kg/m³ | up to 42.9 |
| Shale inhibiting salt | |
| ppb | up to 60 |
| kg/m³ | up to 171.6 |
| Lime^{c} | |
| ppb | up to 30 |
| kg/m³ | up to 85.8 |
| Fluid loss control agent | |
| Ppb | up to 30 |
| kg/m³ | up to 85.8 |
| Aqueous Phase | Remainder to 100% by volume |

^{a}Volume percent is based on the total volume of the drilling fluid.
^{b}The pounds per barrel (ppb) is based upon the final composition of the drilling fluid.
^{c}As used in the specification and claims, the term “lime” means quicklime (CaO), quicklime precursors, and hydrated quicklime (e.g., slaked lime (Ca(OH).sub.2)).

The properties (e.g., low toxicity oil to water ratio, density, etc.) of the drilling fluids of the invention can be adjusted to suit any drilling operation. For example, the drilling fluid is usually formulated to have a volumetric ratio of low toxicity oil to water of about 100:0 to about 40:60 and a density of about 0.9 kg/l (7.5 pounds per gallon (ppg)) to about 2.4 kg/l (20 ppg).

The invert emulsion wellbore fluids are preferably prepared by mixing the constituent ingredients in the following order: (a) low toxicity oil, (b) emulsifier, (c) lime, (d) fluid loss control agent, (e) an aqueous solution comprising water and the shale inhibiting salt, (f) organophilic clay (when employed), (g) oil wetting agent, and (h) weighting agent.

In order to more completely describe the invention, the following non-limiting examples are given. Abbreviations which may be used in this specification have the following meanings: g=grams; rpm=revolutions per minute; sec=seconds; min=minutes; v=volts; psi - pounds per square inch; lb=pounds; sq=square; ft=feet; cp =centipoise; ppb=pounds per 42 gallon barrel; ppg=pounds per gallon; ml=IS milliliters; 1=liter; kg=kilogram; m=meter; COL #D=commercial organophilic lignite (DURATONE); V90 =VASSA LP-90 paraffinic oil; CLVT=Conoco LVT-200 mineral oil; API=American Petroleum Institute; SA=sulfuric acid; A=a partial amide of one mole of diethylenetriamine and one mole of tall oil fatty acid; B=an alkylamidoimidazoline of two moles of tall oil fatty acid and one mole of triethylenetetramine; HR=hot rolled; FLC=fluid loss control; OTCC=organophilic tannin-containing composition; CFL=complete fluid loss.

The commercial organophilic -lignite DURATONE can be obtained from Baroid Drilling Fluids, a Halliburton Company, 3000 N. Sam Houston Parkway E., Houston, Tex. 77032. The commercial lecithin is marketed as YELKIN TS b y ADM, Industrial Commodities, Inc., Grand Prairie, Tex. 75050. Partial amide A is obtained by reacting one (1) mole of diethylenetriamine with one (1) mole of refined tall oil fatty acid at 140° C. for two (2) hours (thus forming the amidoamine of Formula II wherein x=2, y=2, R″ is an aliphatic group from tall oil fatty acid, and R′ is H). The Partial Amide B is obtained by reacting the imidazoline obtained by reacting one (1) mole of triethylenetetramine with one (1) mole of tall oil fatty acid at 265° C. for 40 minutes with one (1) mole of tall oil fatty acid for two (2) hours at 145° C. (thus forming the alkylamidoimidazoline of Formula III wherein x=2, z=2, R″ is an aliphatic group from tall oil fatty acid, and one (1) R′ is H and the other R′ is R″—CO). Conoco LVT-200 mineral oil can be obtained from Conoco, Inc., 600 N. Dairy Ashford Road, Houston, Tex. 77079. VASSA LP-90 oil can be obtained from Vassa, Estado Falcon, Venezuela. BIOBASE internal olefin can be obtained from Shrieve Chemical Company, 1717 Woodstead Court, Houston, Tex. 77380.

The properties of the fluids were evaluated using the tests set forth in API's Recommended Practice RP-13B-1.

### EXAMPLE 1

Two organophilic wattle-containing compositions were prepared as follows: Sample 1-1. 100 grams of Black Wattle extract were mixed with 1000 cc of water and heated to 76.7±° C. for one hour. 20 g of concentrated sulfuric acid were added and mixed 5 minutes. 30 g of Partial Amide A was added and mixed for 15 minutes. 1.43 g of commercial lecithin were added and mixed 5 minutes. 32 g of lime were added and mixed 5 minutes. Thereafter, the slurry was filtered and the filter cake dried at 65.6° C. before grinding the samples to pass through a 60 mesh screen. Sample 1-2. Prepared as Sample 1-1 except that 30 g of sulfuric acid and 48 g of lime were used. The Black Wattle extract was obtained from The Tannin Corp., Peabody, Mass.

### EXAMPLE 2

Two organophilic quebracho-containing compositions were prepared as in Example 1 except that quebracho extract was substituted for the wattle extract and alkylamidoimidazoline B was substituted for the partial amide A. The quebracho extract was obtained from the Unitan SA, Buenos Aires, Argentina.

The samples of examples 1 and 2 and the commercial organophilic lignite, DURATONE, were evaluated as fluid loss control additives in VASSA LP-90, Conoco LVT 200, or diesel oils as follows: 15 grams of sample were mixed with 350 ml of oil for 10 minutes in an Osterizer mixer; the initial API fluid loss of the fluid was then measured; the remaining fluid was poured out of the filtration cell into an Osterizer mixer and mixed with the filtrate and the filter cake for 10 minutes to reconstitute the fluid; the fluid was then hot rolled for 16 hours at 148.9° C. (300° F.) and/or 176.7° C. (350° F.) as set forth in Table 1; the fluid was cooled to room temperature and the API fluid loss was again determined. The data obtained are set forth in Table 1.

The API fluid loss, initial and after hot rolling the fluids for 16 hours at 176.7° C. (350° F.), was determined for fluids containing 28.5 kg/m³ (10 ppb) and 42.75 kg/m³ (15 ppb) of either sample 1-1 or the commercial organophilic lignite DURATONE in the BIOBASE internal olefin oil. The data obtained are set forth in Table 2.

### EXAMPLE 3

Six organophilic quebracho-containing compositions were prepared as in Example 1 containing various concentrations of partial amide A as set forth in Table 3, and the concentrations of sulfuric acid, lime and commercial lecithin used for Sample 1-1. These samples were evaluated as fluid loss control additives at 14.25 kg/m³, 28.5 kg/m³, or 42.75 kg/m³ at (5, 10, or 15 ppb) in the VASSA LP-90 paraffinic oil, the BIOBASE internal olefin, and diesel oil after shearing 10 minutes in an Osterizer mixer. The data obtained are set forth in Table 3.

The data indicates the excellent lowering of the fluid loss in the various oils particularly when the concentration of the partial amide in the OTCC is greater than about 15% by weight, based on the weight of the tannin extract.

### EXAMPLE 4

Six organophilic quebracho-containing compositions were prepared as in Example 1 containing the concentrations of partial amide A, sulfuric acid, lime and commercial lecithin set forth in Table 4. The samples were evaluated as in Example 3. The data obtained are set forth in Table 4. The data indicate that sulfuric acid and commercial lecithin must be reacted with the tannin in order for an efficient fluid loss control additive to be produced.

### EXAMPLE 5

An invert w/o base fluid was prepared by mixing together the following components in the order indicated, with a ten minute mixing time after each addition and a final ten minute mixing time after the barite addition: 7110 ml diesel oil; 150 g CARBO-GEL organophilic clay gelling agent/rheological modifier, 30 ml propylene carbonate organoclay dispersant, 150 ml CARBO-TEQ emulsifier; 240 ml CARBO-MUL emulsifier, 90 g lime; 1770 ml of a 30% by weight calcium chloride solution; and 6870 g barite weighting agent. The CARBO-GEL, CARBO-TEQ, and CARBO-MUL are products of Baker Hughes Inteq, Houston, Tex.

315 ml of this oil base mud was diluted with 35 ml of diesel oil in an Osterizer blender. Thereafter 10 ppb of the OTCC samples set forth in Table 5 were added and sheared 10 minutes. The fluids were then hot rolled at 148.9° C. (300° F.) for 16 hours, cooled, sheared in an Osterizer for 10 minutes and the API rheology, electrical stability, and high temperature, high pressure fluid loss determined. The data obtained are set forth in Table 5.

TABLE 1
42.75 kg/m³ (15 ppb) Sample

| | | API Fluid Loss, ml | | |
|---|---|---|---|---|
| | | | Hot Rolled | Hot Rolled |
| Sample | Oil | Initial | @ 148.9° C. | @ 176.7° C. |
| COL #D | V90 | 1.75 | 24.4 | 250 |
| 1-1 | V90 | 2.6 | 2.4 | — |
| 1-2 | V90 | 1.6 | 2.0 | — |
| 2-1 | V90 | 3.1 | — | 23.5 |
| 2-2 | V90 | 4.5 | — | 5.6 |
| COL #D | CLVT | 2.2 | 36.8 | — |
| 1-1 | CLVT | 5.6 | 5.0 | — |
| 1-2 | CLVT | 4.0 | 3.0 | — |
| COL #D | Diesel | 1.7 | 86.2 | 28.5 |
| 1-1 | Diesel | 2.6 | 7.2 | — |
| 1-2 | Diesel | 2.8 | 2.0 | — |
| 2-1 | Diesel | 2.25 | 3.5 | 7.0 |
| 2-2 | Diesel | 4.6 | 3.8⁽¹⁾ | 10.3 |

TABLE 2

API Fluid Loss, ml
BIOBASE Internal Olefin

| | Sample | | | After Hot Rolling @ |
|---|---|---|---|---|
| Sample | kg/m³ (ppb) | | Initial | 176.7° C. (350° F.) |
| COL #D | 28.5 | (10) | 32.0 | CFL |
| | 42.75 | (15) | 15.0 | CFL |
| 1-1 | 28.5 | (10) | 7.2 | 14.0 |
| | 42.75 | (15) | 2.3 | 5.0 |

TABLE 3
Effect of Partial Amide Concentration on the API Fluid Loss Dispersibility

| | | API Fluid Loss, ml | | | | | | | | |
|---|---|---|---|---|---|---|---|---|---|---|
| | | Vassa LP-90 | | | BIOBASE | | | Diesel | | |
| | %* | kg/m³ Sample | | | kg/m³ Sample | | | kg/m³ Sample | | |
| Sample | A | 14.25 | 28.5 | 42.75 | 14.25 | 28.5 | 42.75 | 14.25 | 28.5 | 42.75 |
| 4-1 | 12.5 | 32 | 14.5 | 11 | 34 | 21.5 | 12 | 27 | 12.5 | 9 |
| 4-2 | 15.0 | 21.5 | 7 | — | 21.5 | 13 | 8 | 15 | 6.5 | — |
| 4-3 | 17.1 | 12.5 | 8 | 4 | 13.5 | 7 | 2.5 | 8 | 4 | 2.5 |
| 4-4 | 24.5 | 7 | 5 | 3 | 8 | 3 | 2 | 3 | 2.5 | 3 |
| 4-5 | 30.0 | 7.5 | — | — | 16.5 | 6.5 | — | 7 | — | — |
| 4-6 | 35.0 | 9 | — | — | 9 | — | — | 8 | — | — |

*%, based on the weight of quebracho

TABLE 4
Effect of Sulfuric Acid Concentration
on the API Fluid Loss Dispersibility

| | Sample | | | | | |
|---|---|---|---|---|---|---|
| | 5-1 | 5-2 | 5-3 | 5-4 | 5-5 | 5-6 |
| %* A | 24.5 | 24.5 | 24.5 | 24.5 | 24.5 | 24.5 |
| %* H₂SO₄ | 0 | 10 | 15 | 20 | 25 | 25 |
| %* Lime | 0 | 16 | 24 | 32 | 40 | 40 |
| %* Lecithin | 1.43 | 1.43 | 1.43 | 1.43 | 1.43 | 0 |
| Oil, ppb Sample | API Fluid Loss, ml | | | | | |
| Vassa, 5 | — | 21.5 | 16 | 13 | 7 | 15 |
| Vassa, 10 | — | 7 | 5 | 4 | 5 | 7 |
| Vassa, 15 | 100 | — | — | — | 3 | 7.5 |
| Biobase, 5 | — | 35 | 18 | 23.5 | 8 | 27 |
| Biobase, 10 | — | 8 | 6 | 5.5 | 3 | 5 |
| Biobase, 15 | 68 | — | — | — | 2 | 7.5 |
| Diesel, 5 | — | 31 | 20.5 | 13 | 3 | 9.5 |
| Diesel, 10 | — | 7.5 | 5 | 5.5 | 2.5 | 5 |
| Diesel, 15 | 130 | — | — | — | 3 | 3.5 |

*% based on the weight of Quebracho

TABLE 5

| | 28.5 kg/m³ (10 ppb) OTCC | | |
|---|---|---|---|
| Fluid | 6-0 | 6-1 | 6-2 |
| OTCC | None | 1-1 | 1-2 |

Fann Rheology

| | | | |
|---|---|---|---|
| 600 rpm | 50 | 58 | 59 |
| 300 rpm | 26 | 33 | 32 |
| Plastic Viscosity, cp. | 24 | 25 | 27 |
| Yield Point, Pa (lb/100 sq. ft.) | 0.96 (2) | 3.84 (8) | 2.4 (5) |
| 10 sec Gel Strength, Pa | 2.83 | 3.36 | 3.36 |
| 10 min Gel Strength, Pa | 3.84 | 5.28 | 4.32 |
| Electrical Stability, volts | 413 | 431 | 400 |
| Fluid Loss @ 148.9° C., 3450 kPa, ml | 31.6 | 4.8 | 5.6 |

### EXAMPLE 6

There were added to 350 ml of the invert emulsion oil base mud of Example 5 1 g CARGO-GEL, 2 ml CARBO-TEQ, and 2 ml CARBO-MUL while mixing 9 minutes with a MULTIMIXER. 15 g of the OTCC samples set forth in Table 6 were added and the mixing continued for 5 minutes. The fluids were then hot rolled 16 hours at 176.7° C. (350° F.), cooled, and evaluated as in Example 5. The data obtained are set forth in Table 6.

TABLE 6

| | 42.75 kg/m³ (15 ppb) OTCC | | |
|---|---|---|---|
| Fluid | 6-0 | 6-1 | 6-2 |
| OTCC | None | 1-1 | 1-2 |

Fluid Hot Rolled at 176.7° C. (350° F.) for 16 hours

Fann Rheology

| | | | |
|---|---|---|---|
| 600 rpm | 71 | 87 | 81 |
| 300 rpm | 39 | 49 | 44 |
| Plastic Viscosity, cp. | 32 | 38 | 37 |
| Yield Point, Pa (lb/100 sq. ft.) | 3.36 (7) | 5.28 (11) | 3.36 (7) |
| 10 sec Gel Strength, Pa | 1.92 | 2.4 | 1.92 |
| 10 min Gel Strength, Pa | 5.28 | 3.84 | 2.4 |
| Electrical Stability, volts | 692 | 582 | 837 |
| Fluid Loss @ 148.9° C., 3450 kPa ml | 25.2 | 7.2 | 12.4 |

What is claimed is:

1. An organophilic tannin-containing composition which is the reaction product of a polyamidoamine, a tannin, a commercial lecithin, and an acid, wherein the polyamidoamine is selected from the group consisting of (I), (II), (III), (IV), and mixtures thereof, wherein (I) has the empirical molecular formula R-NR′—(CₓH₂ₓNR′)_{y}H, (II) has the empirical molecular formula R″—CO—NH—(CₓH₂ₓNR′)_{z}H, and (III) has the empirical molecular formula 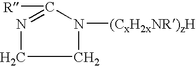
where 2≦x≦3; y≧1; z≧2; R is an aliphatic group containing from 8 to 30 carbon atoms; R′ is selected from the group consisting of H and R″—O, and mixtures thereof; R″ is an aliphatic group containing from 7 to 29 carbon atoms; and wherein at least one of the R′ groups are H, and wherein (IV) is the reaction product of an oxidized hydrocarbon wax and a polyalkylene polyamine in which at least one amino group of the polyalkylene polyamine is not amidated, and wherein the concentration of the commercial lecithin is from about 1% to about 3% by weight based on the weight of the tannin.

2. The composition of claim 1 wherein the tannin is selected from the group consisting of quebracho, wattle, and mixtures thereof.

3. The composition of claim 2 wherein the acid is sulfuric acid.

4. The composition of claim 1, 2, or 3 wherein the concentration of the polyamidoamine is greater than 15% by weight, based on the weight of the tannin.

5. The composition of claim 1, 2, or 3 wherein x=3 in compounds represented by formula I, x=2 in the compounds represented by formulas II and III, 1≦y≦7, 2≦z≦8, R is an aliphatic group containing from 12 to 22 carbon atoms, and R″ is an aliphatic group containing from 11 to 21 carbon atoms.

6. The composition of claim 4 wherein x=3 in compounds represented by formula I, x=2 in the compounds represented by formulas II and III, 1≦y≦7, 2≦z≦8, R is an aliphatic group containing from 12 to 22 carbon atoms, and R″ is an aliphatic group containing from 11 to 21 carbon atoms.

7. The composition of claim 1 to which has been added a base to raise the pH of the composition to within the range from about 6 to about 11.

8. An oleaginous wellbore fluid comprising an oil and the organophilic tannin-containing composition of claim 1, 2, or 3.

9. An oleaginous wellbore fluid comprising an oil and the organophilic tannin-containing composition of claim 4.

10. An oleaginous wellbore fluid comprising an oil and the organophilic tannin-containing composition of claim 5.

11. An oleaginous wellbore fluid comprising an oil and the organophilic tannin-containing composition of claim 6.
